(19) United States
(12) Patent Application Publication
(10) Pub. No.: US 2026/0029245 A1
(43) Pub. Date: Jan. 29, 2026

(54) APPARATUS AND METHOD FOR PREDICTING AVAILABILITY DATA OF ELECTRIC VEHICLE CHARGING POINTS

(71) Applicant: HERE GLOBAL B.V., EINDHOVEN (NL)

(72) Inventor: AMARNATH NAYAK, MUMBAI (IN)

(73) Assignee: HERE GLOBAL B.V., EINDHOVEN (NL)

(21) Appl. No.: 18/782,236

(22) Filed: Jul. 24, 2024

(51) Int. Cl. G01C 21/36; G06N 20/00

(52) U.S. Cl. CPC G01C 21/3679; G06N 20/00

(57) ABSTRACT

An apparatus and method for predicting availability data of electric vehicle charging points (EVCPs) are provided. The apparatus receives EVCP data associated with each of a plurality of EVCPs. The apparatus determines clustering features for each of the plurality of EVCPs based on the EVCP data. The clustering features comprise a duration parameter, a predefined charging status parameter, a charging gap parameter, or a combination thereof. The apparatus generates clusters using a first model based on the clustering features. Each of the clusters comprises at least one of the plurality of EVCPs. The apparatus trains a second model to predict availability data associated with each EVCP within each of the clusters based on a data point associated with one or more EVCPs within said cluster.

### TECHNOLOGICAL FIELD

The present disclosure relates generally to electric vehicle infrastructure management, and more specifically relates to apparatus and methods to predict real-time availability data of electric vehicle charging points (EVCPs).

### BACKGROUND

The rise of electric vehicles (EVs) represents a significant shift towards sustainable transportation, driven by concerns over environmental impact and dependence on fossil fuels. As the adoption of EVs continues to grow, so does the demand for reliable and accessible EVCPs for charging such EVs. However, accurately forecasting the availability of the EVCPs presents various challenges. Conventional forecasting methods are complex, resource-intensive tasks, and impractical for the vast number of charging locations worldwide. Moreover, such forecasting methods often overlook crucial factors, thereby leading to suboptimal predictions and inefficient management of EVCP resources. This may further result in underutilization or congestion at certain EVCPs.

Therefore, there is a need for optimized forecasting methods for efficient prediction of availability data of EVCPs.

### BRIEF SUMMARY

An apparatus, a method and a computer programmable product are provided for predicting availability data of EVCPs.

In one aspect, an apparatus for predicting availability data of EVCPs is disclosed. The apparatus includes at least one processor and at least one non-transitory memory including computer program code instructions. The computer program code instructions are configured to, when executed, cause the apparatus to receive EVCP data associated with EVCPs. The computer program code instructions cause the apparatus to determine one or more clustering features for each of the plurality of EVCPs based on the EVCP data. The one or more clustering features includes a duration parameter, a predefined charging status parameter, a charging gap parameter, or a combination thereof. The computer program code instructions cause the apparatus to generate, using a first model, one or more clusters based on the one or more clustering features. Each of the one or more clusters includes at least one of the plurality of EVCPs. The computer program code instructions cause the apparatus to train a second model to predict availability data associated with each EVCP within each of the one or more clusters based on a data point associated with one or more EVCPs within said cluster.

In additional embodiments, the computer program code instructions further cause the apparatus to receive ground-truth availability data associated with each of the plurality of EVCPs, determine a confidence score of the second model based on the availability data and the ground-truth availability data, and update the one or more clusters based on the confidence score using the first model.

In additional embodiments, to update the one or more clusters, the computer program code instructions cause the apparatus to compare the confidence score with a confidence threshold, and responsive to the confidence score failing to satisfy the confidence threshold, generate a plurality of updated clusters using the first model by increasing a number of EVCPs the one or more clusters.

In additional embodiments, the computer program code instructions cause the apparatus to re-train the second model to predict the availability data associated with each EVCP within each of the plurality of updated clusters based on a data point associated with one or more EVCPs within said updated cluster.

In additional embodiments, the computer program code instructions cause the apparatus to receive vehicle information of a vehicle associated with the geographic area. The vehicle information includes location data associated with the vehicle and battery charge data associated with the vehicle. Further, the computer program code instructions cause the apparatus to identify one or more EVCPs from the one or more clusters for the vehicle based on the vehicle information and the availability data.

In additional embodiments, the computer program code instructions cause the apparatus to generate navigation instructions for the vehicle from a starting location to one of the one or more EVCPs from the one or more clusters.

In additional embodiments, the computer program code instructions cause the apparatus to generate, using the first model, the one or more clusters based on one or more additional clustering features. The one or more additional clustering features includes a record parameter, a utilization parameter, or a combination thereof.

In additional embodiments, the EVCP data includes geographic area data, weather condition associated with a geographic area and one or more events associated with the geographic area of each of the plurality of EVCPs.

In additional apparatus embodiments, the duration parameter is a ratio of a number of first charging events among second charging events that occurred at each of the plurality of EVCPs and a number of the plurality of charging events that occurred at each of the plurality of EVCPs. In an example, each of the first charging events is less than a predefined duration.

In additional apparatus embodiments, the predefined charging status parameter may be a ratio of a number of one or more events that occurred at each of the plurality of EVCPs and a number of status change for each of the plurality of EVCPs. In an example, each of the one or more events is defined as a status other than a charging status or an unavailable status.

In additional apparatus embodiments, the charging gap parameter is an average duration between two consecutive charging events that occurred at each of the plurality of EVCPs.

In another aspect, a method for predicting availability data of EVCPs is provided. The method includes receiving EVCP data associated with a plurality of EVCPs and determining one or more clustering features for each of the plurality of EVCPs based on the EVCP data. The one or more clustering features comprises a duration parameter, a predefined charging status parameter, a charging gap parameter, or a combination thereof. The method further includes generating, using a first model, one or more clusters based on the one or more clustering features. Each of the one or more clusters comprises at least one of the plurality of EVCPs. The method further includes training a second model to predict availability data associated with each EVCP within each of the one or more clusters based on a data point associated with one or more EVCPs within said cluster.

In some embodiments, the method further includes receiving ground-truth availability data associated with each of the plurality of EVCPs, determining a confidence score of the second model based on the predicted availability data and the ground-truth availability data, and updating, using the first model, the one or more clusters based on the confidence score.

In some embodiments, the method further includes comparing the confidence score with a confidence threshold, and responsive to the confidence score failing to satisfy the confidence threshold, generating, using the first model, a plurality of updated clusters by increasing a number of EVCPs the one or more clusters.

In some embodiments, the method further includes re-training the second model to predict the availability data associated with each EVCP within each of the plurality of updated clusters based on a data point associated with one or more EVCPs within said updated cluster.

In some embodiments, the method further includes receiving vehicle information of a vehicle associated with the geographic area and identifying one or more EVCPs from the one or more clusters for the vehicle based on the vehicle information and the availability data. The vehicle information includes location data and battery charge data.

In some embodiments, the method further includes generating navigation instructions for the vehicle from a starting location to one of the one or more EVCPs from the one or more clusters.

In some embodiments, the method further includes generating, using the first model, the one or more clusters based on one or more additional clustering features. The one or more additional clustering features includes a record parameter, a utilization parameter, or a combination thereof.

In yet another aspect, a computer programmable product for predicting availability data of EVCPs is disclosed. The computer programmable product includes a non-transitory computer readable medium having stored thereon computer executable instructions, which when executed by one or more processors, cause the one or more processors to carry out operations including receiving EVCP data associated with each of a plurality of EVCPs and determining one or more clustering features for each of the plurality of EVCPs based on the EVCP data. The one or more clustering features comprises a duration parameter, a predefined charging status parameter, a charging gap parameter, or a combination thereof. The operations further include generating, using a first model, one or more clusters based on the one or more clustering features. Each of the one or more clusters comprises at least one of the plurality of EVCPs. The operations further include training a second model to predict availability data associated with each EVCP within each of the one or more clusters based on a data point associated with one or more EVCPs within said cluster

In some embodiments, the operations further include receiving ground-truth availability data associated with each of the plurality of EVCPs, determining a confidence score of the second model based on the predicted availability data and the ground-truth availability data, and updating, using the first model, the one or more clusters based on the confidence score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment within which an apparatus for predicting availability data for EVCPs is implemented, in accordance with an embodiment of the disclosure;

FIG. 2 illustrates a block diagram of the apparatus of FIG. 1, in accordance with an embodiment of the disclosure;

FIG. 3A illustrates a block diagram of exemplary operations for generating one or more clusters using a first model, in accordance with an embodiment of the disclosure;

FIG. 3B illustrates a block diagram of exemplary operations for predicting availability data based on the one or more clusters using a second model, in accordance with an embodiment of the disclosure;

FIG. 3C illustrate a block diagram of exemplary operations for re-training of the second model, in accordance with an embodiment of the disclosure; and

FIG. 4 illustrates a flowchart of a method for identifying one or more EVCPs for a vehicle, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatus and methods are shown in block diagram form only in order to avoid obscuring the present disclosure. Some embodiments of the present disclosure will now be described more fully hereinafter with reference to the accompanying drawings, in which some, but not all, embodiments of the disclosure are shown.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data,” “content,” “information,” and similar terms may be used interchangeably to refer to data capable of being displayed, transmitted, received and/or stored in accordance with embodiments of the present disclosure. Thus, use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the description and should not be regarded as limiting. Any heading utilized within this description is for convenience only and has no legal or limiting effect.

The present disclosure is directed towards an apparatus, and methods for generating availability data to forecast availability of EVCPs, thereby facilitating efficient routing of users or vehicles to the EVCPs with minimal waiting times. An EVCP may be an electric vehicle charging station or an equipment, such as an electric vehicle supply equipment (EVSE), that supplies electric power for recharging an electric vehicle (EV). By accurately predicting when the EVCPs will be available, the techniques described in the present disclosure ensures that charging of the vehicles is conducted in a planned manner, thereby significantly increasing the effectiveness of charging infrastructure. This predictive capability supports the widespread use of EVs by optimizing the utilization of the EVCPs, preventing congestion at individual points, and evenly distributing the load across a network of the EVCPs. As a result, the users experience reduced wait times and more reliable access to the charging infrastructure, while operators benefit from improved operational efficiency and infrastructure management. The present disclosure not only enhances the user experience, but also promotes the adoption of EVs by ensuring a more efficient and effective charging network.

In particular, the present disclosure provides significant technical improvement by clustering the EVCPs, thereby reducing an amount of data that needs to be processed and/or communicated to predict the availability data. The clustering method may speed up the training process and reduce the computational burden on a machine learning (ML) model that processes data associated with EVCPs. This is especially beneficial given that the number of EVCPs and the amount of data generated for each of the EVCPs are continuously increasing. For example, individually processing data generated for each EVCP and using data related to said EVCP to train the ML model may adversely impact real-time operation of the ML model because such processes are resource intensive and time consuming. The present disclosure describes techniques for clustering EVCPs sharing similar features to reduce an amount of data to be processed for predicting availability data for any of the EVCPs in real-time.

The present disclosure may provide an apparatus, a method, and a computer programmable product for predicting availability data for EVCPs in real-time within a geographic area. The apparatus in the present disclosure may generate one or more clusters of EVCPs by using an ML model (referred to as a first model, hereinafter) and trains another ML model (referred to as a second model, hereinafter) to predict availability data associated with each EVCP within each of the one or more clusters

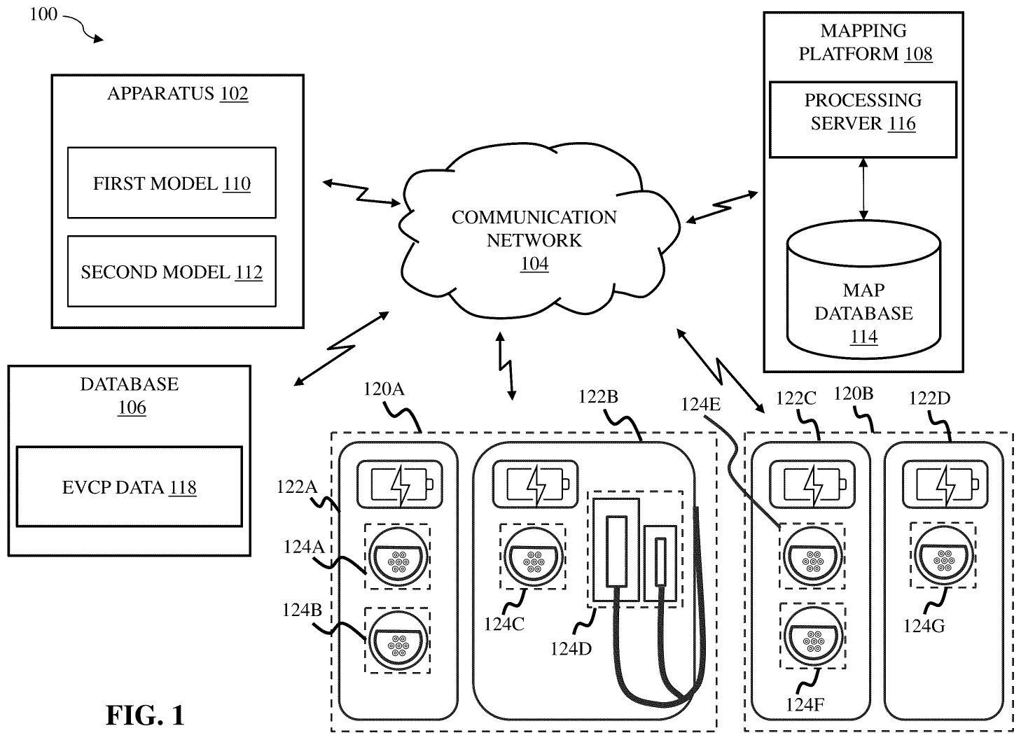

FIG. 1 illustrates a block diagram of a network environment 100 comprising an apparatus 102 implemented for predicting availability data for EVCPs, in accordance with an embodiment of the disclosure. The apparatus 102 may include a first model 110 and a second model 112. With reference to FIG. 1, there is further shown a database 106, a mapping platform 108, and a communication network 104. The mapping platform 108 may include a map database 114 and a processing server 116. The network environment 100 further includes pools of charging stations, depicted as a first pool 120A and a second pool 120B (collectively referred to as pools 120).

Pursuant to the present disclosure, a pool refers to a set of charging stations that are aggregated together due to their common properties (e.g., common geographic locations, a common charging station controller, a common owner or an administrative entity, etc.). In the illustrated embodiment, the first pool 120A and the second pool 120B are in different geographic locations. A charging station may refer to a device or a physical infrastructure that includes one or more EVSE. A charging station may be equipped with hardware and software components for facilitating charging batteries of EVs. For example, a charging station may be equipped with one or more charging cables, one or more control units, one or more user interfaces, one or more communication interfaces, or a combination thereof. In the illustrated embodiment, the first pool 120A includes charging stations 122A and 122B, and the second pool 120B includes charging stations 122C and 122D. The charging stations 122A, 122B, 122C, and 122D will be collectively referred to as charging stations 122, herein. An EVSE is a device that may control power supply to a single EV in a single charging session. In one embodiment, an EVSE may include a single connector for providing power to an EV during a charging session. In one embodiment, an EVSE may include a plurality of connectors, and only one of the plurality of connectors may be activated to provide power to an EV during a charging session. In the illustrated embodiment, the charging station 122A includes EVSE 124A and 124B, the charging station 122B includes EVSE 124C and 124D, the charging station 122C includes EVSE 124E and 124F, and the charging station 122D includes EVSE 124G. The EVSE 124A, 124B, 124C, 124D, 124E, 124F, and 124G will be collectively referred to as an EVSE 124, herein. Herein, an EVSE or a charging station will be referred as an EVCP.

The EVSE 124 may be various types and have various configurations, ranging from residential charging points for home use to public charging stations located in parking lots, streets, or other public spaces.

Each of the EVSE 124 may support different charging standards and levels of power delivery, such as level 1 charging at 120 volts (V) AC, level 2 charging at 240V AC, DC fast charging at 200-600 V DC, ultra-fast charging at up to 1000V DC, or a combination thereof. Further, the EVSE 124 may be implemented as one or more wall-mounted charging points, one or more pedestal charging points, one or more portable charging points, one or more integrated charging points integrated with another infrastructure, for example, parking spaces, residential buildings, commercial buildings, etc., or a combination thereof.

It may be noted that the illustration of the network environment 100 to include only two pools 120A and 120B is only exemplary and should not be construed as a limitation. Particularly, the network environment 100 may include a multitude of pools. These pools may be connected to the apparatus 102 or third-party platforms to provide data associated therewith. For example, data generated by and/or associated with the pools may be stored in the database 106 as EVCP data 118.

The first model 110 and the second model 112 may correspond to machine learning (ML) models. The ML models may be trained to identify a relationship between inputs, such as a set of features in a training dataset, and output predictive values. The ML models may be defined by corresponding hyper-parameters, for example, a number of weights, cost function, input size, number of layers, and the like. The hyper-parameters of the ML models may be tuned, and weights may be updated to move towards a global minimum of a cost function for the corresponding ML models. After several epochs of the training on the feature information in corresponding training datasets, the ML models may be trained to output a result for an input or a set of inputs.

The ML models may include electronic data, such as, for example, a software program, code of the software program, libraries, applications, scripts, or other logic or instructions for execution by a processing device, such as the apparatus 102. The ML models may include code and routines configured to enable a computing device, such as the apparatus 102 to perform one or more operations associated with determining availability data for EVCPs. For example, the first model 110 is configured to output one or more clusters, where each of the one or more clusters include one or more EVCPs. Specifically, the first model 110 may generate the one or more clusters based on certain clustering features associated with each of the EVCPs. In another example, the second model 112 is configured to output prediction for availability data for the EVCPs within the one or more clusters. Specifically, the second model 112 may predict the availability data associated with each of EVCPs within each of the one or more clusters.

Additionally, or alternatively, the ML models may be implemented using hardware including a processor, a microprocessor (e.g., to perform or control the performance of one or more operations), a field-programmable gate array (FPGA), or an application-specific integrated circuit (ASIC). Alternatively, in some embodiments, the ML models may be implemented using a combination of hardware and software. Examples of the ML models may include, but are not limited to, K-means clustering model, a Deep Neural Network (DNN) model, an Artificial Neural Network (ANN) model, a Long Short-Term Memory (LSTM) network model, an ANN-LST m model, a Convolutional Neural Network (CNN) model, a CNN-Recurrent Neural Network (RNN) model, a Connectionist Temporal Classification (CTC) model, or a Hidden Markov model.

In an embodiment, the apparatus 102 may be communicatively coupled to other components not shown in FIG. 1 via the communication network 104. All the components in the network environment 100 may be coupled directly or indirectly to the communication network 104. The components described in the network environment 100 may be further broken down into more than one component and/or combined together in any suitable arrangement. Further, one or more components may be rearranged, changed, added, and/or removed.

In an example embodiment, the apparatus 102 may be the processing server 116 of the mapping platform 108 and therefore may be co-located with or within the mapping platform 108. The database 106 may be configured to receive, store, and transmit data that may be collected from vehicles, the pools 120, and/or other databases associated with users, vehicles and EVCPs. In accordance with an embodiment, the database 106 may be the map database 114 of the mapping platform 108 and therefore may be co-located with or within the mapping platform 108. The apparatus 102 may comprise suitable logic, circuitry, and interfaces that may be configured to predict availability data of one or more EVCPs.

The embodiments disclosed herein provide the apparatus 102 to optimally predict availability data of EVCPs within a geographic area. The availability data for an EVCP may indicate, for example, availability of the EVCP for performing a charging session during different time periods throughout a day. Embodiments of the present disclosure provide techniques for accurately predicting availability data of a plurality of EVCPs across various geographic regions. The availability data of an EVCP may be predicted based on a data point associated with a cluster that includes the EVCP. The present disclosure predicts the availability data of the EVCP based on usage patterns and operational characteristics. By predicting availability data of EVCPs, the present disclosure enables users to plan their charging activities more effectively, ensuring that the user may have access to an EVCP when needed while ensuring low waiting time. Ultimately, the present disclosure optimizes the utilization of EVCPs by selecting the most efficient EVCPs based on availability forecasts, thereby enhancing the overall user experience and efficiency of charging infrastructure.

In an embodiment, the apparatus 102 may be connected to a vehicle, such as an EV, via the communication network 104. The EV may utilize the availability data predicted by the apparatus 102 for performing or engaging in a charging session. For example, the EV may cause a user interface associated thereto to present the availability data to a user, generate a trip to a EVCP based on the availability data, autonomously maneuver to the EVCP based on the trip, or a combination thereof. In an embodiment, the apparatus 102 may be integrated with a vehicle, and a user of the vehicle may access the features of the apparatus 102 via a user interface, such as an infotainment system of the vehicle.

The availability data for an EVCP may include comprehensive information indicating a current and an anticipated status of an EVCP. The availability data includes real-time updates on whether the EVCP is available, occupied, or out of service. For instance, the availability data may include information of operating status of the EVCP. In an example, the availability data may indicate that the EVCP is available for charging, i.e., is free or unoccupied at a given time period. For example, the availability data may include a prediction that the EVCP will be available from 9:00 AM to 9:30 AM next morning for charging. In another example, the availability data may indicate that the EVCP will be occupied 9:30 AM to 11:00 AM next morning. In yet another example, the availability data may indicate a time period during which the EVCP may be out-of-service, such as closed, or undergo maintenance, etc. Additionally, the availability data includes predicted availability of EVCPs based on historical usage trends and predictive analytics that forecast future availability, ensuring users can efficiently locate and utilize the EVCPs with less waiting time when needed. By integrating real-time data with historical patterns, the availability data enables optimal utilization of charging infrastructure, minimizes wait times, and enhances the overall user experience for EV owners. The availability data also supports operational efficiency by informing maintenance schedules and identifying underutilized EVCPs that may benefit from strategic adjustments. For example, if an EVCP frequently shows a pattern of high usage followed by periods of inactivity, the availability data may help in planning maintenance during low-demand times, thus maximizing uptime and user satisfaction.

In operation, computer-readable instructions cause the apparatus 102 to receive the EVCP data 118 associated with EVCPs. The EVCP data 118 may refer to the information associated with the pools 120A and 120B that may be collected and stored in the database 106 or the map database 114. The EVCP data 118 may include various attributes and parameters related to EVCPs, such as, but not limited to geographic area data, physical characteristics, operational status data, and usage pattern data. Additionally, the EVCP data 118 may include details about charging connectors available at the pools 120A and 120B, charging rates, and any associated amenities or services provided at the pools 120A and 120B.

In an example, the EVCP data 118 may include physical characteristics of an EVCP, such as a type of EVCP, thereby indicating a charging capacity and compatibility with different EVs. The EVCP data 118 may further include a number of connectors available at each of the charging stations 122. Further, the EVCP data 118 may include operational status data associated with the EVSE 124 which may serve as a historical as well as a real-time indicator of operating conditions of the charging stations 122. In an example, the operational status data may be an available status when an EVCP is ready to initiate a new charging session (e.g., the EVCP is functional, the EVCP is not being used, and the EVCP is not blocked by a physical obstruction). In an example, the operational status data may be a blocked status indicating that an EVCP is inaccessible due to a physical obstruction, such as a parked vehicle. In an example, the operational status data may be a charging status indicating that an electric vehicle is actively being charged at an EVCP. In an example, the operational status data may be an inoperative status or an out of order status indicating that an EVCP is temporarily or permanently non-functional. In an example, the operational status data may be a planned status indicating that an EVCP is scheduled for installation and will be operational soon. In an example, the operational status data may be a removed status indicating that an EVCP has been discontinued or removed from service. In an example, the operational status data may be a reserved status indicating that an EVCP is reserved for a specific user or time period. In an example, the operational status data may be associated with an under-maintenance status indicating that an EVCP is under maintenance and will be available after the maintenance. In an example, the operational status data may be an unknown status indicating that a status information of an EVCP is unavailable.

In an embodiment, computer-readable instructions may cause the apparatus 102 to determine one or more clustering features for EVCPs based on the EVCP data 118. In an example, the one or more clustering features may refer to attributes that may be utilized for grouping data points into clusters during clustering process. The one or more clustering features refer to specific characteristics of the EVCPs that aid in identifying similarities and patterns among the EVCPs.

In an embodiment, the one or more clustering features comprises a duration parameter, a predefined charging status parameter, a charging gap parameter, a record parameter, a utilization parameter, or a combination thereof. In such embodiment, the duration parameter for an EVCP indicates a ratio of a number of first charging events among second charging events that occurred at the EVCP and a number of the second charging events. Each of the first charging event is less than a first predefined duration (e.g., 2 hours), and the number of the second charging events is recorded over a second predefined duration (e.g., 6 months). The predefined charging status parameter for an EVCP indicates a ratio of a number of events that occurred at the EVCP and a number of status change for the EVCP. Each of the events is defined as an operational status other than a charging status or an unavailable status. For example, such status may be non-functional status, available status, blocked status, inoperative status, out-of-order status, under-maintenance status, planned status, removed status, reserved status, or unknown status. Furthermore, the charging gap parameter for an EVCP indicates an average of a gap between two consecutive charging events at the EVCP. This may measure a time interval between consecutive charging sessions at the EVCP. The record parameter for an EVCP indicates a number of data entries associated with the EVCP that is stored in the database 106. The utilization parameter for an EVCP indicates a ratio of a total charging duration for the EVCP and a total duration of the EVCP (e.g., a duration of which an EVCP was/has been provided for service).

Further, the computer-readable instructions cause the apparatus 102 to generate, using the first model 110, one or more clusters based on the one or more clustering features. In an example, a cluster refers to a group or a set of EVCPs. The EVCPs grouped in one cluster may exhibit similar characteristics or behavior patterns. These characteristics are determined based on the clustering features, such as the duration parameter, the predefined charging status parameter, the charging gap parameter, and/or other relevant parameters associated with the plurality of EVCPs. Clustering involves grouping together one or more EVCPs that share similar attributes or exhibit comparable patterns in terms of their operational dynamics, usage profiles, and geographic locations. A cluster represents a distinct subset of the plurality of EVCPs within the overall EVCP network, allowing for more targeted analysis, prediction, and management of charging infrastructure.

In an example, the first model 110 is a clustering-based ML model. The first model 110 may utilize a clustering algorithm to generate the one or more clusters. For example, the first model 110 may generate the one or more clusters using K-means algorithm. The K-means algorithm is a clustering algorithm for grouping similar data points. Each cluster of the one or more clusters may represent a subset of EVCPs located within a pre-defined boundary of a geographic region, such as a same city, state, country, etc., enabling more localized analysis and management of the plurality of EVCPs. In another example, the one or more clusters may be generated based on clustering entire country, the first model 110 may partition the plurality of EVCPs into groups based on their geographic distribution across the entire country. Each cluster of the one or more clusters may represent a subset of the plurality of EVCPs located within different regions or areas across the country. This nationwide clustering approach enables a macro-level analysis and management of charging infrastructure, considering factors such as country-wide transportation networks, population distribution, and regional variations in EV adoption.

Moreover, each of the one or more clusters includes at least one of the plurality of EVCPs. For instance, each of the one or more clusters may contain varying numbers of EVCPs, with some clusters having only a few EVCPs while others may contain a larger number of EVCPs. For example, one cluster may include 10 EVCPs, while another cluster may comprise 100 EVCPs.

Further, the computer-programmable instructions cause the apparatus 102 to train the second model 112 to predict availability data associated with each EVCP within each of the one or more clusters based on a data point associated with one or more EVCPs within said cluster. In an embodiment, the second model 112 may be a time series forecast model. The second model 112 is trained based on each of the one or more clusters by utilizing information associated with said cluster to predict the availability data for each of the EVCPs within each of the one or more clusters. The second model 112 leverages the characteristics and patterns observed for a cluster. These characteristics and patterns may be associated with similar clustering features of one or more EVCPs grouped in the cluster. The characteristics and patterns may indicate, for example, historical patterns associated with the one or more EVCPs in the cluster. By analyzing the characteristics and patterns indicative of charging behaviors and status transitions of the EVCPs in the cluster, the second model 112 learns to predict the availability data for each of the EVCPs in the cluster. In an example, the availability data for an EVCP in the cluster may indicate a time period when an operating status of the EVCP is forecasted to be the available status for performing a charging session. Similarly, availability data for each of the EVCPs in each of the clusters are predicted. This allows for more accurate predictions of EVCP availability, tailored to the specific characteristics and usage patterns observed within each cluster, thereby enhancing the efficiency and effectiveness of the availability prediction process. Further, as the second model 112 is trained on the one or more clusters, specifically cluster points instead of individual datapoints of the EVCPs, therefore, the training of the second model 112 may be resource effective. As a result, costs associated with training may be reduced while improving the accuracy of predicted output.

In an example, the second model 112 is trained using the clusters as input data, allowing the second model 112 to learn patterns and relationships specific to each cluster. For example, the training of the second model 112 includes utilization of parameters associated with each of the one or more clusters as a data point for predicting availability data. For instance, the training process of the second model 112 involves using each of the one or more clusters as an individual datapoint for predicting availability data. By treating each cluster as a single data point, the second model 112 may identify the characteristics and patterns specific to that cluster, enabling it to forecast the availability of EVCPs within the cluster accurately.

The present disclosure focusses on optimizing accurate prediction of availability data of EVCPs by leveraging clustering techniques and predictive modeling. Further, the present disclosure provides a solution to optimize the forecasting of the availability data of the EVCPs by clustering the EVCPs into groups or clusters based on corresponding similar clustering features, making it more efficient, cost-effective, and reliable.

While the illustrated embodiment depicts certain components of the network environment 100 as certain structures and individual entities, the disclosure may not be so limiting. For example, in certain embodiments, the apparatus 102, the database 106, the mapping platform 108, or a combination thereof may be combined as a single entity. In certain embodiments, one or more components of the apparatus 102, such as the first model 110, the second model 112, or a combination thereof, may be embodied within the mapping platform 108. In certain embodiments, the EVCP data 118 may be stored in a database of the apparatus 102, a database of the mapping platform 108, or a combination thereof.

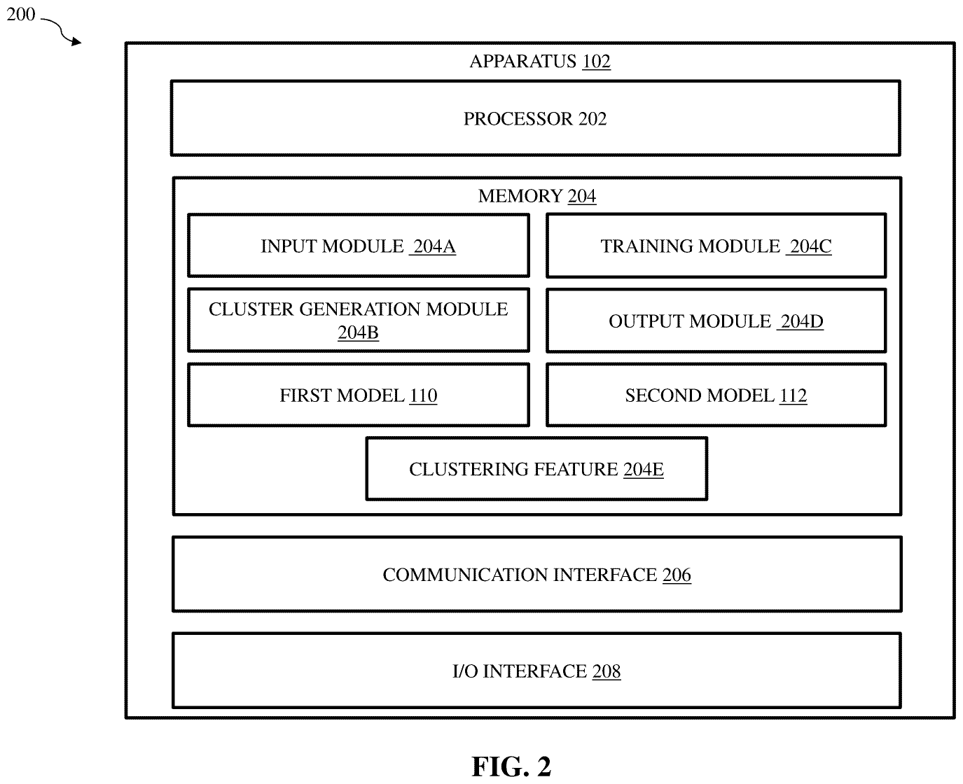

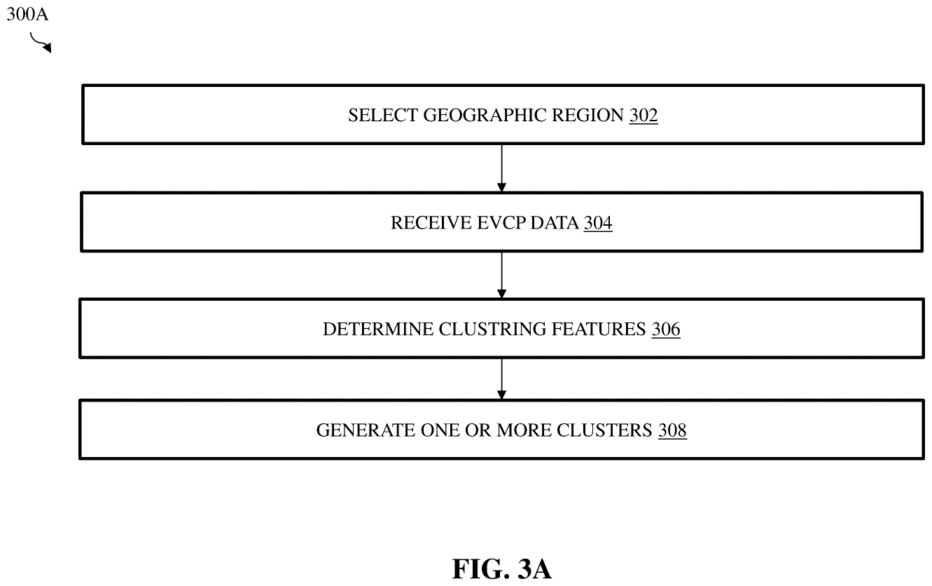

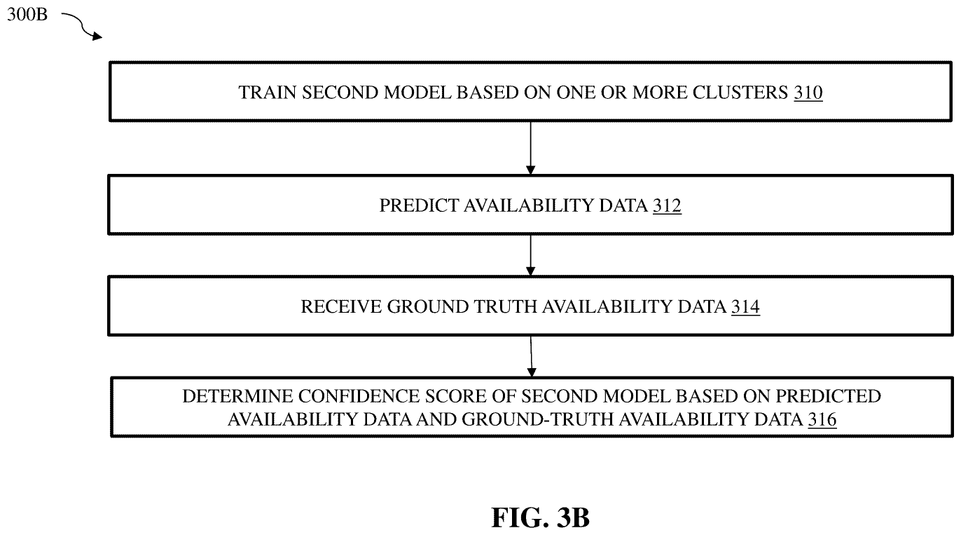

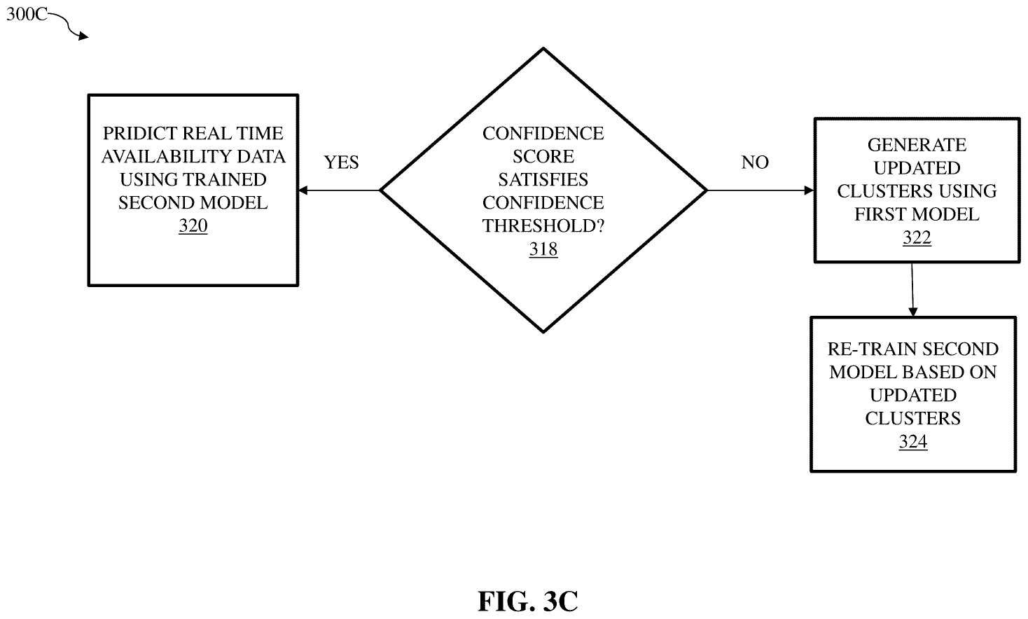

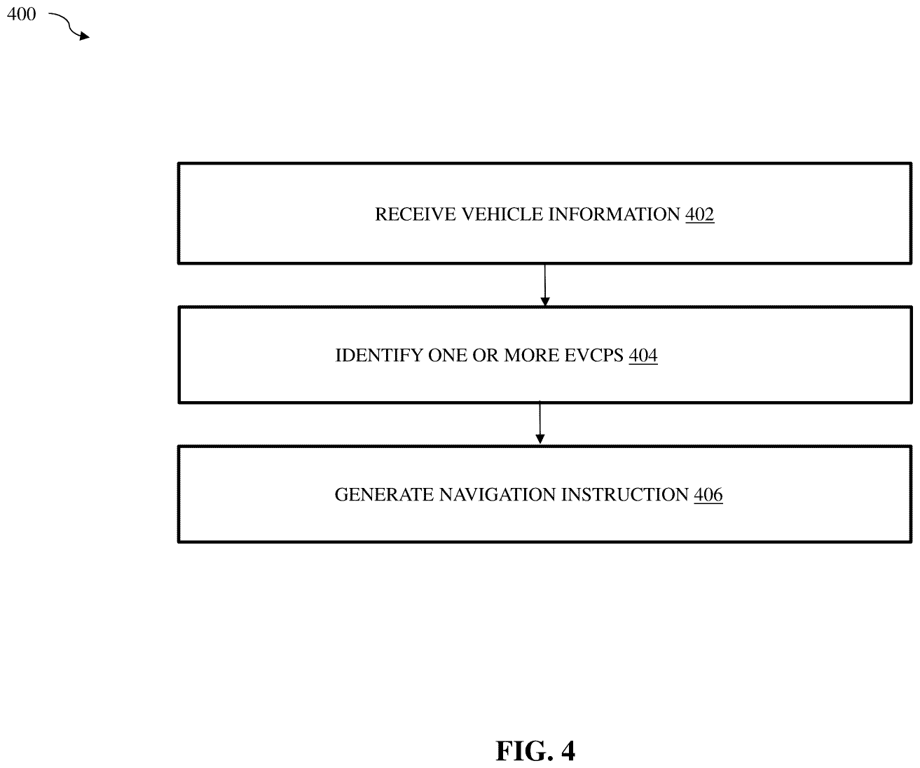

In some embodiments, the apparatus 102 includes additional components for enabling the operations of predicting the availability data of the EVCPs. Details of the operations of the apparatus 102 for predicting the availability data are further described in conjunction with, for example, FIG. 2, FIG. 3A, FIG. 3B, FIG. 3C, and FIG. 4.

FIG. 2 illustrates an exemplary block diagram 200 of the apparatus 102, in accordance with an embodiment of the disclosure. FIG. 2 is explained in conjunction with elements of FIG. 1. The apparatus 102 may include at least one processor (referred to as a processor 202, hereinafter), at least one non-transitory memory (referred to as a memory 204, hereinafter), a communication interface 206, and an input/output (I/O) interface 208. The processor 202 may be connected to the memory 204, the communication interface 206, and the I/O interface 208 through wired or wireless connections. The memory 204 may include an input module 204A, a cluster generation module 204B, a training module 204C, and an output module 204D, the first model 110, the second model 112, and a clustering feature 204E. Each of the input module 204A, the cluster generation module 204B, the training module 204C, and the output module 204D, the first model 110, and the second model 112 may include computer-readable codes that may be executed via the processor 202 to perform its designated function. Although FIG. 2 illustrates that the apparatus 102 includes the processor 202, the memory 204, the communication interface 206, and the I/O interface 208, the disclosure may not be so limiting, and the apparatus 102 may include fewer or more components to perform the same or other functions of the apparatus 102.

In an embodiment, the input module 204A and the output module 204D may cause the I/O interface 208 to perform functions via the processor 202. In some embodiments, the input module 204A may cause the I/O interface 208 to receive input data (such as EVCP data 118 and/or user inputs), and the output module 204D may cause the I/O interface 208 to output processed data (such as the availability data, and the like).

In accordance with an embodiment, the apparatus 102 may store data that may be generated by the modules while performing corresponding operations or may be retrieved from the database 106 and/or other database, such as the map database 108B associated with the apparatus 102 and/or EVCPs in the memory 204. For example, the data may include vehicle information, traffic information, user information, distance information, and environmental information.

The processor 202 and the memory 204 of the apparatus 102 may be configured to perform one or more operations associated with predicting availability data for the EVCPs. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the apparatus 102.

For example, when the processor 202 is embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment 100 may be accessed using the communication interface 206 of the apparatus 102. The communication interface 206 may provide an interface for accessing various features and data stored in the apparatus 102.

The input module 204A may be configured to receive the EVCP data 118 associated with each of a plurality of EVCPs. In an example, the EVCP data 118 associated with a EVCP may include geographic area data associated with the EVCP, weather condition associated with a geographic area of the EVCP and one or more events associated with the geographic area of the EVCP. The input module 204A may be configured to obtain vehicle information associated with a vehicle. In an embodiment, the vehicle information may include location data associated with the vehicle and battery charge data associated with the vehicle. In an embodiment, the vehicle information may be received from one or more sensors onboard the vehicle. For example, the one or more sensors may include one or more image sensors, one or more LIDARs, one or more speed sensors, one or more global positioning sensors (GPS), and the like.

In an example, the input module 204A may be configured to receive, obtain, or retrieve input data. In an example, the input data may be received from, for example, the database 106, and/or other databases associated with the apparatus 102, and a navigation or delivery operation service provider, etc. Pursuant to the present disclosure, the input data includes the EVCP data 118. The EVCP data 118 may include the data associated with plurality of EVCPs, such as the status of each of the plurality of EVCPs. Such data may provide valuable insights into the usage patterns, operational performance, and availability trends of individual EVCPs over predefined time periods.

The cluster generation module 204B may be configured to generate one or more clusters based on the one or more clustering features determined by the EVCP data 118. In an example, the cluster generation module 204B may be configured to execute or utilize the first model 110 to generate the one or more clusters. The clusters are generated based on the determined one or more clustering features 204A. In an embodiment, the first model 110 may be trained to generate the one or more clusters based on the one or more clustering features.

In an example, the cluster generation module 204B may be configured to generate the one or more clusters. Each of the one or more clusters may include one or more EVCPs. In an example, the cluster generation module 204B may utilize clustering algorithms and techniques. For instance, the cluster generation module 204B may analyze the EVCP data 118, which may include parameters such as the geographic area data, charging rates, historical usage patterns, and operational statuses of the EVCPs. By examining the parameters of the cEVCP, the cluster generation module 204B may determine clustering features of each of the EVCPs. The clustering features are certain parameters that may be directly or indirectly derived from the parameters of the EVCPs in the EVCP data 118. Further, the cluster generation module 204B identifies similarities and patterns among the EVCPs based on its clustering features, and allows them to be grouped into one or more clusters based on commonalities.

The clustering process facilitates several key functionalities within the charging station. Firstly, the cluster generation module 204B enables the identification of the one or more clusters with similar usage profiles, helping stakeholders understand which stations experience similar levels of demand or activity.

Furthermore, the cluster generation module 204B aids in predicting the availability data of the EVCPs by grouping the EVCPs into clusters with comparable historical usage patterns. By leveraging past data, the apparatus 102 can forecast future availability more accurately, allowing effective planning and utilization of charging infrastructure the clusters reduce processing power, memory requirements, and well as delays arising due to communications of large amount of EVCP-specific data. Since processing is done on cluster level, resources utilized for training the second model for predicting the availability data may reduce.

The training module 204C may be configured to train the second model 112 to predict availability data associated with each of the plurality of EVCPs. In an embodiment, the training module 204C may be configured to re-train the second model 112 in certain iterations to improve accuracy of the predicted availability data. In an embodiment, the training module 204C trains the second model 112 to employ machine learning algorithms and techniques to analyze past charging behavior for each of the clusters and generate or output availability data for EVCPs grouped in the clusters.

The output module 204D may be configured to output the availability data associated with each of the EVCPs in the geographic area. In an embodiment, the output module 204D may be configured to output and transmit the availability data to a down-stream application, such as a navigation application. In another example, the output module 204D may output the availability data for display or store the availability data, such as within the database 106. In certain cases, the availability data may be output as audio alerts informing the availability of the EVCPs.

In certain embodiments, the output module 204D may be configured to identify one or more EVCPs from the one or more clusters for an EV based on vehicle information and the availability data of the EV. For example, depending on a location of the EV, a current status of battery charge, and for example, trip data of the EV, the output module 204D may identify one or more EVCPs for the EV. The one or more EVCPs may include EVCPs that may be closest to a current location of the EV, may lie within a trajectory to be covered by the EV, may have less wait time or is available during a time period when EV arrives, etc. In this regard, the output module 240D may also be configured to generate navigation instructions for the EV from a starting location to one of the one or more EVCPs from the one or more clusters. The staring location may be a current location of the EV or a user-specified location. Moreover, an EVCP from the one or more EVCPs may be selected for navigation based on a user-input or based on the EVCP satisfying a condition, such as the EVCP being the closest, having the least wait time for use, etc. In an example, the output module 204D may be configured to generate user readable or user-understandable navigation instructions for an available EVCP, such as routing messages, notifications, warning messages, etc., to provide navigation recommendation based on the prediction of the availability data by the second model 112. In another example, the output module 204D may be configured to generate a machine-readable navigation instructions that causes the EV to autonomously maneuver to a designated EVCP.

The output module 204D may be further configured to output the navigation instructions as, for example, notifications, pop-ups, offline navigation instructions, voice alerts, etc. In an example, the output module 204D may be configured to transmit the availability data to the map database 114. In an example, the output module 204D may send routing messages to user equipment, such as user equipment on-board the vehicle to enable a user or a driver of the vehicle to travel. The output module 204D may also send routing messages to other user equipment associated with the vehicle or other vehicles that may have to travel to the EVCP.

The memory 204 may further store the first model 110, and the second model 112. The memory 204 may also store a confidence score, the clustering features 204E, the EVCP data 118, and other information or data that may be generated by the apparatus 102 during its operation. The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the apparatus 102 to carry out various operations in accordance with embodiments of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In an embodiment, the memory 204 is configured to store the clustering feature 204E. In an example, the one or more clustering features 204E includes a duration parameter, a predefined charging status parameter, a charging gap parameter, a record parameter, a utilization parameter, or a combination thereof.

In an embodiment, the memory 204 is configured to store the EVCP data 118. The EVCP data 118 may include the geographic area data that refers to information pertaining to the spatial characteristics and attributes of specific geographic regions where the EVCPs are located. The geographic area data may include various geographical parameters such as latitude and longitude coordinates, postal codes, administrative boundaries such as cities, states, countries, and other spatial identifiers that define the location and extent of the EVCP network. Additionally, the geographic area data may include contextual information about the surrounding environment, such as terrain features, proximity to key landmarks or infrastructure, and demographic characteristics of the population within the area. Further, the geographic area data may denote the precise location of the charging station, facilitating accurate mapping and navigation services for the user.

In an embodiment, the EVCP data 118 also includes weather condition associated with a geographic area, and one or more events associated with the geographic area of each of the plurality of EVCPs. Weather conditions may have a substantial impact on the usage and availability of EVCPs. For example, extreme weather events like storms or heatwaves may affect people's travel patterns, leading to increased or decreased demand for charging services. Additionally, certain weather conditions, such as heavy rain or snow, may influence the accessibility or safety of EVCPs, potentially affecting their availability to users. Furthermore, the EVCP data 118 also incorporates information about one or more events associated with the geographic area of each EVCP. These events may include local festivals, concerts, sports events, or other gatherings that attract significant crowds or cause traffic disruptions in the vicinity of the EVCPs. Events of this nature can impact the utilization and demand for EVCPs, as they may lead to increased vehicular traffic or the presence of visitors unfamiliar with the area seeking charging services.

In some example embodiments, the I/O interface 208 may operate with the processor 202 and the memory 204. The I/O interface 208 may include a display and, in some embodiments, may also include a keyboard, a mouse, a touch screen, touch areas, soft keys, or other input/output mechanisms. In one embodiment, the apparatus 102 may include a user interface circuitry configured to control at least some functions of one or more I/O interface elements such as the display and, in some embodiments, a plurality of speakers, a ringer, one or more microphones and/or the like. The processor 202 and/or the I/O interface 208 circuitry including the processor 202 may be configured to control one or more operations of one or more I/O interface elements through computer program instructions (for example, software and/or firmware) stored on the memory 204 accessible to the processor 202. The processor 202 may further render notifications associated with the navigation instructions, such as traffic data, traffic conditions, traffic congestion value, ETA, routing information, road conditions, driving instructions, etc., on the user equipment or audio or display onboard the vehicles via the I/O interface 208.

The communication interface 206 may include the input interface and output interface for supporting communications to and from the apparatus 102 or any other component of which the apparatus 102 may communicate. The communication interface 206 may be any means such as a device or circuitry embodied in either hardware or a combination of hardware and software that is configured to receive and/or transmit data to/from a communications device in communication with the apparatus 102. In this regard, the communication interface 206 may include, for example, an antenna (or multiple antennae) and supporting hardware and/or software for enabling communications with a wireless communication network. Additionally, or alternatively, the communication interface 206 may include the circuitry for interacting with the antenna(s) to cause transmission of signals via the antenna(s) or to handle receipt of signals received via the antenna(s). In some environments, the communication interface 206 may alternatively or additionally support wired communication. As such, for example, the communication interface 206 may include a communication modem and/or other hardware and/or software for supporting communication via cable, digital subscriber line (DSL), universal serial bus (USB), or other mechanisms. In some embodiments, the communication interface 206 may enable communication with a cloud-based network to enable deep learning, such as using the first model 110 or the second model 112 (that may be hosted on the cloud-based network).

FIG. 3A is a block diagram 300A that illustrates exemplary operations for generating one or more clusters using the first model 110, in accordance with an embodiment of the disclosure. FIG. 3A is explained in conjunction with elements from FIG. 1 and FIG. 2. The exemplary operations illustrated in the block diagram 300A may start at 302 and may be performed by any computing system, apparatus, or device, such as by the apparatus 102 of FIG. 1. Although illustrated with discrete blocks, the exemplary operations associated with one or more blocks of the block diagram 300A may be divided into additional blocks, combined into fewer blocks, or eliminated, depending on the particular implementation.

At 302, a geographic region for generating the one or more clusters is determined. It is contemplated that predicting availability of EVCPs can be improved if the focus of the prediction is narrowed to regions that are impacted by similar and local features (e.g., weather and holiday patterns). Therefore, in certain embodiments, the apparatus 102 may select a city as the geographic region for generating the one or more clusters. It is also contemplated that prediction of availability of EVCPs may benefit from one form of information over another. For example, for the purpose of predicting availability of EVCPs, using information indicating statistics associated with a region may be advantageous over using information that simply indicates a region and time. Therefore, in certain embodiments, the apparatus 102 may select a country as the geographic region for generating the one or more clusters because information associated with a country generally provides larger quantities of numerical data that can be used for predicting availability of EVCPs.

At 304, the EVCP data 118 is received. In an embodiment, the apparatus 102 may be configured to receive the EVCP data 118 associated with each of a plurality of EVCPs within the geographic region. In an example, the EVCP data 118 may be received from the database 106 or the map database 114. The EVCP data 118 for an EVCP may include details such as location, duration of a charging session, a number of charging events in a day, a type of charging connectors available, charging power, energy transferred during each session, and an operating status recorded during multiple historical time periods. For instance, the operating status may include, but is not limited to, an available status, an unavailable or in-use or charging status, an out of order status, an under-maintenance status, a blocked status, a planned status, a reserved status, and an unknown status. Further the EVCP data 118 may include geographic area data, weather condition associated with a geographic area and one or more events associated with the geographic area of each of the plurality of EVCPs. The geographic area data may provide spatial information about the location and distribution of the plurality of EVCPs within a specified geographic region. The geographic area data may include geographic coordinates (latitude and longitude) pinpointing the position of each of a plurality of EVCPs within the specified geographic area. Additionally, the geographic area data may encompass metadata about the region, such as administrative boundaries, points of interest, terrain characteristics, and environmental factors. The weather condition associated with the geographic area of the vehicle may include, but not limited to, environmental conditions such as temperature, humidity, precipitation, wind speed, and the like.

At 306, one or more clustering features are determined. In an embodiment, the apparatus 102 may be configured to determine the one or more clustering features 204A for each of the plurality of EVCPs based on the EVCP data 118. The one or more clustering features 204E may include a duration parameter, a predefined charging status parameter, a charging gap parameter, a record parameter, a utilization parameter, or a combination thereof.

The duration parameter may correspond to a ratio of a number of first charging events among second charging events that occurred at an EVCP and a number of the second charging events. Each of the first charging event is less than a first predefined duration (e.g., 2 hours), and the number of the second charging events is recorded over a second predefined duration (e.g., 6 months). In one embodiment, the duration parameter may be only acquired for EVCPs that support DC charging. EVCPs with a higher duration parameter indicate a larger proportion of quick charging events, which could imply a higher turnover rate of EVs or a preference for rapid charging among users. On the other hand, the EVCPs with a lower duration parameter may experience longer charging sessions, suggesting a different user demographic, or charging behavior.

The predefined charging status parameter is a ratio of a number of first charging events among second charging events that occurred at each of the plurality of EVCPs and a number of the second charging events. Each of the one or more first events is defined as an operational status other than a charging status or an unavailable status. For example, such status may be non-functional status, available status, blocked status, inoperative status, out-of-order status, under-maintenance status, planned status, removed status, reserved status, or unknown status. EVCPs with a lower predefined charging status parameter may indicate a greater proportion of time spent actively charging EVs or being unavailable for new charging session, reflecting high demand or frequent usage. Conversely, EVCPs with a lower predefined charging status parameter may suggest more frequent availability for charging or longer periods of non-use.

The charging gap parameter is an average duration between two consecutive charging events that occurred at each of the plurality of the EVCPs. For example, the charging gap parameter may refer to the average duration between consecutive charging events at each EVCP. To calculate the charging gap parameter for a specific EVCP, the apparatus 102 may analyze timestamps of all charging events recorded at the EVCP. The charging gap parameter is then determined by computing an average duration between two consecutive charging events, measured in units of time. The charging gap parameter provides insights into the usage patterns and demand for charging services at each EVCP. EVCPs with shorter average charging gaps indicate higher demand and more frequent utilization, potentially suggesting a need for additional infrastructure or optimization of charging resources. Conversely, a longer average charging gap may indicate lower demand or sporadic usage patterns.

The record parameter for an EVCP may indicate a number of entries associated with the EVCP that is stored in the database 106. For example, the record parameter may include data such as, but not limited to, reference identifier of the EVCP, date and timestamp associated with charging sessions at the EVCP (for example, start and end time of each of the charging sessions, and duration of the charging sessions), and the like. In an example, the utilization parameter may indicate data associated with usage pattern of the EVCP.

The utilization parameter for an EVCP indicates a ratio of a total charging duration for the EVCP and a total duration of the EVCP (e.g., a duration of which the EVCP was/has been provided for service or installed at a location).

At 308, one or more clusters are generated. In an embodiment, the apparatus 102 generates the one or more clusters within the geographic region. In an embodiment, the apparatus 102 may be configured to generate, using the first model 110, one or more clusters based on the one or more clustering features 204E. Each of the one or more clusters includes at least one of the plurality of EVCPs. In an example, the first model 110 using the clustering algorithm, such as but not limited to the K-means clustering or hierarchical clustering, to the combined dataset of the one or more clustering features 204E.

In an embodiment, the cluster generation module 204B may be configured to group the plurality of EVCPs into N distinct groups based on their characteristics and behavior. Each of the one or more clusters represents a subset of the EVCPs. For example, EVCPs forming a cluster may share similar attributes or exhibit similar patterns in terms of charging duration, utilization, status proportions, and other relevant features. By creating N clusters, the first model 110 organizes the EVCPs into manageable groups, allowing for more effective analysis, prediction, and management of the charging infrastructure network.

FIG. 3B is a block diagram 300B that illustrates exemplary operations for predicting availability data based on the one or more clusters using the second model 112, in accordance with an embodiment of the disclosure. FIG. 3B is explained in conjunction with elements from FIG. 1, FIG. 2 and FIG. 3A. The exemplary operations illustrated in the block diagram 300B may start at 310 and may be performed by any computing system, apparatus, or device, such as by the apparatus 102 of FIG. 1. The operation at 310 may follow the operation at 308 of FIG. 3A. Although illustrated with discrete blocks, the exemplary operations associated with one or more blocks of the block diagram 300B may be divided into additional blocks, combined into fewer blocks, or eliminated, depending on the particular implementation.

At 310, the second model 112 is trained based on the one or more clusters. The one or more clusters may be generated by the first model 110. Thereafter, the generated one or more clusters are fed to the second model 112 as input for its training. The second model 112 is configured to analyze the similarities and patterns of each of the one or more clusters to adjust its weights. In an example, the second model 112 gets trained based on attributes of the clusters. These attributes of a cluster may indicate similar parameters of one or more EVCPs that are grouped in the cluster. In an embodiment, the second model 112 may be a time series forecast model.

In an example, the second model 112 is trained on the one or more clusters in one or more epochs to generate prediction data. The prediction data may include, for example, predicting operating status for EVCPs grouped in the clusters for future time periods.

The training process of the second model 112 may use the one or more clusters as representative entities or groupings of the plurality of EVCPs. Each of the one or more clusters serves as a data point from which the second model 112 draws patterns and relations to predict availability data associated with each of the plurality of EVCPs within the one or more clusters.

In an embodiment, the training module 204C may be configured to train the second model 112 for predicting the availability data for the plurality charging stations based on the one or more clustering features 204A, the geographic area data, and the EVCP data 118. The second module 112 employs machine learning algorithms and techniques to analyze past charging behavior and generate models capable of forecasting EVCP availability.

At 312, availability data is predicted. In an embodiment, the apparatus 102 may be configured to use the trained second model 112 to predict the availability data associated with EVCPs within each of the one or more clusters. In an example, based on a data point associated with a cluster, features of the EVCPs in the cluster are determined. Thereafter, the availability data for a EVCP that is a part of the cluster is determined.

To this end, the prediction of the availability data by the trained second model 112 for a time period may enhance EVCP infrastructure in a geographic area. By leveraging the one or more clustering features 204A, the geographic data, the historical EVCP data 204E, the training module 204C creates predictive models that capture the complex relationships between various factors influencing the EVCP availability. The second model 112 is trained on large datasets including charging events, cluster assignments, and other relevant parameters to identify patterns and trends indicative of future availability.

For example, the training of the second model 112 utilizes the N clusters as input data points, with each cluster representing a distinct subset of the EVCPs 118 with similar characteristics. By incorporating cluster-specific information into the training process, the second model 112 may learn patterns and relationships specific to each cluster, improving the accuracy and effectiveness of the predictions.

The second model 112 receives, as an input, the characteristics and patterns observed within each of the one or more clusters. Further, each of the one or more clusters may correspond to a data point upon which the second model 112 may have been trained, thereby reducing a number of data points on which the second model 112 gets trained. The data points associated with one or more EVCPs within said cluster may refer to a data point that represents the cluster. Thereafter, the second model 112 may forecast the availability of EVCPs within the geographic area. By incorporating cluster-specific information into the training process, the second model 112 may capture the nuances and variations in availability patterns across different subsets of EVCPs, thereby enabling to predict the availability data for charging stations more accurately.

In an example, the prediction process involves leveraging the learned patterns and relationships from the training phase to forecast the availability status of EVCPs within each cluster. For example, using the trained second model 112, the apparatus 102 may generate predictions for various aspects of EVCP availability, such as whether the EVCP will be available, in use, or out of order at a given time. Further, the predicted availability data provides insights into the forecasted future state of EVCPs, allowing stakeholders to anticipate and plan for potential changes in station availability. This information can be used to optimize charging station usage, minimize downtime, and improve overall efficiency in managing electric vehicle charging operations.

At 314, ground-truth availability data is received. In an embodiment, the processor 202 may be configured to receive the ground-truth availability data associated with each of the plurality of EVCPs. The ground-truth availability data may include real-time observations associated with each of the plurality of EVCPs. In an example, the ground-truth availability data may correspond to records of the availability status of each of the plurality of EVCPs, indicating whether each EVCP is currently available, in use, or out of order.

In an example, the predicted availability data, generated by the trained second model 112, represents the forecast of the availability status of EVCPs within each cluster. These predictions are compared with the ground-truth availability data, which consists of actual observations or records of the availability status of EVCPs collected over a specified period. By comparing the predicted availability data with the ground-truth availability data, the apparatus 102 assesses the performance and effectiveness of the second model 112 in accurately forecasting EVCP availability. The comparison process provides valuable feedback on the predictive capabilities of the apparatus 102, guiding further refinement and optimization of the second model 112.

At 316, a confidence score is determined for the second model 112. In an embodiment, the apparatus 102 may be configured to determine the confidence score of the second model 112 based on the availability data and the ground-truth availability data. For example, the confidence score reflects a degree of confidence or certainty associated with the predictions made by the second model 112. Further, the confidence score may be employed to evaluate performance and reliability of the second model 112. The second model 112 may serve as a quantitative measure of the model's accuracy and effectiveness in forecasting the availability status of the EVCPs.

To determine the confidence score, the apparatus 102 analyzes the consistency between the predicted availability data generated by the second model 112 and the ground-truth availability data. Discrepancies or deviations between the predicted and ground-truth availability data are taken into account when calculating the confidence score. Further the determination of the confidence score, takes into account various factors, such as the consistency between the predicted availability data and the ground-truth availability data, as well as the overall performance of the model in accurately forecasting availability data of EVCPs. This enables stakeholders to assess the trustworthiness and effectiveness of the predictive model in real-world scenarios.

FIG. 3C is a block diagram 300C that illustrates exemplary operations for re-training of the second model 112, in accordance with an embodiment of the disclosure. FIG. 3C is explained in conjunction with elements from FIG. 1, FIG. 2, FIG. 3A and FIG. 3B. The exemplary operations illustrated in the block diagram 300C may start at 318 and may be performed by any computing system, apparatus, or device, such as by the apparatus 102 of FIG. 1 or the processor 202 of FIG. 2. The operation at 318 may follow the operation at 316 of FIG. 3B. Although illustrated with discrete blocks, the exemplary operations associated with one or more blocks of the block diagram 300C may be divided into additional blocks, combined into fewer blocks, or eliminated, depending on the particular implementation.

At 318, a determination is made to check whether a confidence score satisfies the confidence threshold or not. The confidence score may be the confidence score calculated at the operation at 316 of FIG. 3B.

In an embodiment, a confidence score satisfies the confidence threshold when the confidence score is greater than the confidence threshold. A confidence score greater than the confidence threshold may indicates a higher level of agreement between the predictions of the second model 112 and the actual availability status of the EVCPs, suggesting greater reliability and accuracy in the second model's performance. Conversely, a confidence score lesser than the confidence threshold may indicate potential inaccuracies or uncertainties in the second model's predictions, prompting further refinement of the second model 112.

In an example, upon comparison, when the confidence score satisfies the confidence threshold, the operation proceeds to 320. On the contrary, when the confidence score does not satisfy the confidence threshold (e.g., the confidence score is less than or equal to the confidence threshold), the operation proceeds to 322.

At 320, when the confidence score satisfies the confidence threshold, the trained second model 112 may be deployed for real-time availability data prediction. The apparatus 102 is configured to use the trained second model 112 for predicting the real time availability data of an EVCP.

At 322, a plurality of updated clusters are generated. In an embodiment, the apparatus 102 may be configured to generate, using the first model 110, the one or more updated clusters based on the confidence score. In an embodiment, if the confidence score fails to satisfy the confidence threshold, the apparatus 102 may be configured to generate, using the first model 110, a plurality of updated clusters by increasing a number of the one or more clusters. For example, the first model 110 generates a number of clusters, and each of the number of clusters includes at least one EVCP. When the confidence score fails to satisfy the confidence threshold, the apparatus 102 may be configured to update the number of clusters by increasing the number of clusters. In an embodiment, the apparatus 102 may increase the number of clusters by an increment.

At 324, the second model 112 is re-trained. In an embodiment, the apparatus 102 may be configured to re-train the second model to predict the availability data associated with each of the EVCPs within each of the plurality of updated clusters based on a data point associated with one or more EVCPs within said updated cluster.

In one embodiment, subsequent to re-training the second model 112 based on the plurality of updated clusters, the apparatus 102 determines a performance of the second model 112 (e.g., by comparing availability data output by the second model 112 to ground-truth availability data). If the performance of the second model 112 improves, the apparatus 102 may repeat the processes of: (1) updating the plurality of updated clusters by increasing the number of the plurality of updated clusters; (2) re-training the second model 112 based on the plurality of updated clusters; and (3) measure the performance of the second model 112. As long as the performance improves, the apparatus 102 may repeat these processes. It is contemplated, however, increasing the number of clusters inevitably increases the amount of resources (e.g., processing and memory resources and time) required to train a model for each cluster. Thus, in one embodiment, the apparatus 102 may repeat said processes until a predefined number of EVCPs remain in each of the updated clusters. For example, the predefined number of EVCPs may be 10. For each iteration of the repeated processes, the apparatus 102 compares the confidence score resulting from measuring the performance of the second model 112 to the confidence threshold. Based on the comparison, the apparatus 102 may deploy the second model 112, proceed with the subsequent iteration of the repeated processes, or generate a message indicating that the second model 112 did not satisfy the confidence threshold and a number of EVCPs remaining in each of the updated clusters is the predefined number (e.g., 10).

In one embodiment, if increasing a number of clusters does not improve the performance of the second model 112, the apparatus 102 may generate a plurality of updated clusters by increasing a number of EVCPs for each cluster. Then, the apparatus 102 re-trains the second model 112 based on the plurality of updated clusters and determines the performance of the second model 112. As long as the performance improves and the number of EVCPs for each cluster does not exceed a predefined number (e.g., 50 EVCPs), the apparatus 102 may repeat the processes of: (1) increasing the number of EVCPs for each cluster; (2) re-training the second model 112 based on the plurality of updated clusters; and (3) determining the performance of the second model 112. For each iteration of the repeated processes, the apparatus 102 compares the confidence score resulting from measuring the performance of the second model 112 to the confidence threshold. Based on the comparison, the apparatus 102 may deploy the second model 112, proceed with the subsequent iteration of the repeated processes, or generate a message indicating that the second model 112 did not satisfy the confidence threshold and a number of EVCPs remaining in each of the updated clusters is the predefined number (e.g., 50).

In one embodiment, the apparatus 102 may perform processes of: (1) generating a number of updated clusters by performing a combination of modifying a number of clusters and modifying a number of EVCPs in each cluster; (2) re-training the second model 112 based on the updated clusters; and (3) measuring the performance of the second model 112. The apparatus 102 may repeat these processes as long as the performance improves and certain conditions are met (e.g., a number of EVCPs in each cluster does not exceed 50 and is greater than 10 and the confidence score resulting from measuring the performance of the second model 112 did not satisfy the confidence threshold).

In one embodiment, the second model 112 may be re-trained for every predefined period (e.g., 3 months) to predict real-time availability data. In an example, the training module 204C is configured to re-train the second model 112 based on the updated clusters. For example, by incorporating the updated clusters, the second model 112 may better capture the complexities and nuances of the EVCP data 118, leading to more accurate and reliable predictions of availability data associated with the plurality of EVCPs.

FIG. 4 illustrates a flowchart 400 of a method for identifying one or more EVCPs for a vehicle, in accordance with an embodiment of the disclosure. FIG. 4 is explained in conjunction with elements from FIG. 1, FIG. 2, and FIG. 3A, FIG. 3B and FIG. 3C. The operations of the exemplary method may be executed by any computing system, for example, by the apparatus 102 of FIG. 1. The operations of the flowchart 400 may start at 402.

At 402, vehicle information is received. In an embodiment, the apparatus 102 may be configured to receive the vehicle information of a vehicle associated with the geographic area. In an example, the vehicle information comprises location data and battery charge data. For instance, the location data may include GPS coordinates or other positional information that identifies the exact position of the vehicle within the geographic area. The battery charge data may include metrics such as the remaining battery capacity, charging status, or estimated range based on the current charge level. By gathering this vehicle information, the apparatus 102 may assess the vehicle's proximity to one or more available EVCPs, determine the feasibility of reaching a charging point based on the remaining battery charge, and provide recommendations or navigation instructions to optimize the charging process.

At 404, one or more EVCPs is identified. In an embodiment, the apparatus 102 may be configured to identify one or more EVCPs from one or more clusters. In an embodiment, the apparatus 102 may be configured to identify the one or more EVCPs from the one or more clusters. The one or more EVCPs from the one or more clusters for the vehicle is identified based on the vehicle information and availability data. For example, the apparatus 102 is configured to identify an EVCP from the one or more available EVCPs for the vehicle. This determination is based on the vehicle information received, such as the vehicle's location and battery charge data, along with the predicted real-time availability data of the EVCPs. By analyzing this information, the apparatus 102 may recommend or select a most suitable EVCP(s) for the vehicle, ensuring convenient access to charging infrastructure based on the vehicle's current needs and the availability of charging resources.

At 406, navigation instructions are generated. In an embodiment, the apparatus 102 may be configured to generate the navigation instructions for the vehicle from a starting location to one of the one or more EVCPs from the one or more clusters. In at least one embodiment, the apparatus 102 may be configured to generate navigation instructions for the vehicle from the starting location to one of the one or more EVCPs from the one or more clusters. In an embodiment, the apparatus 102 is configured to generate navigation instructions for the vehicle based on an EVCP from the at least one EVCP identified for the vehicle. For example, leveraging the available EVCPs, the apparatus 102 determines the optimal EVCP for the vehicle's needs and generates navigation guidance accordingly. These instructions provide the vehicle with a route to reach the selected EVCP efficiently, taking into account factors such as distance, traffic conditions, and EVCP availability. By offering personalized navigation instructions, the apparatus 102 ensures that vehicle owners can easily locate and access charging facilities, facilitating seamless charging experiences.

In one embodiment, the navigation instruction for the route may be dynamically adjusted to provide real-time feedback on traffic condition of the route, including aspects such as congestion, average speed, predicted condition etc.

In one embodiment, a user may want to travel to an EVCP, for example, using an EV. Examples of the EV may include, but is not limited to, an electric two-wheeler, an electric cycle, an electric car, an electric bus, an electric truck, etc. In one embodiment, the apparatus 102 may be on-board on a vehicle. In one embodiment, the apparatus 102 may be installed in or on a vehicle. The vehicle may refer to a form of transportation device capable of autonomous, semi-autonomous, or manual operation, utilizing one or more electric motors for propulsion on or above ground surfaces. In an example, the vehicle encompasses any apparatus designed to transport goods or passengers over land, water, or air. The vehicle extends to include various components, system, and accessories associated with transportation devices, such as propulsion system, control mechanisms, navigation system, safety features, energy storage devices, and communication system. While traditionally associated with land vehicles, such as cars and trucks, the vehicle may also include aircraft and watercraft. Implementation of the embodiments of the present disclosure to other types of vehicles may be apparent to a person skilled in the art.

Accordingly, blocks of the flowcharts 300A, 300B, 300C, and 400 support combinations of means for performing the specified functions and combinations of operations for performing the specified functions. It will also be understood that one or more blocks of the flowcharts 300A, 300B, 300C, and 400 and combinations of blocks in the flowcharts 300A, 300B, 300C, and 400 can be implemented by special purpose hardware-based computer apparatus which perform the specified functions, or combinations of special purpose hardware and computer instructions.

Alternatively, the apparatus 102 may comprise means for performing each of the operations described above. In this regard, according to an example embodiment, examples of means for performing operations may comprise, for example, the processor 202 and/or a device or circuit for executing instructions or executing an algorithm for processing information as described above.

On implementing the flowcharts 300A, 300B, 300C, and 400 disclosed herein, the end result generated by the apparatus 102 is a tangible navigation recommendation based on available EVCP.

Returning to FIG. 1, the communication network 104 may be wired, wireless, or any combination of wired and wireless communication networks, such as cellular, Wi-Fi, internet, local area networks, or the like. In some embodiments, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (e.g. LTE-Advanced Pro), 5G New Radio networks, international telecommunication union (ITU)-international mobile communications (IMT) 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

In another embodiment, the apparatus 102 may be embodied as a cloud-based service, a cloud-based application, a cloud-based platform, a remote server-based service, a remote server-based application, a remote server-based platform, or a virtual computing system. In yet another example embodiment, the apparatus 102 may be an OEM (Original Equipment Manufacturer) cloud. The OEM cloud may be configured to anonymize any data received by the apparatus 102, such as from a set of road attributes, before using the data for further processing, such as before sending the data to the first model 110 (or to the map database 114). For an example, anonymization of the data may be done by the mapping platform 108.

The mapping platform 108 may comprise suitable logic, circuitry, and interfaces that may be configured to store one or more map attributes and sensor data associated with traffic on link segments. The mapping platform 108 may be configured to store and update map data indicating the traffic data along with other map attributes, road attributes, and traffic entities, in the map database 114. The mapping platform 108 may include techniques related to, but not limited to, geocoding, routing (multimodal, intermodal, and unimodal), clustering algorithms, and machine learning in location-based solutions, natural language processing algorithms, and artificial intelligence algorithms. Data for different modules of the mapping platform 108 may be collected using a plurality of technologies including, but not limited to drones, sensors, connected cars, cameras, probes, and chipsets. In some embodiments, the mapping platform 108 may be embodied as a chip or chip set. In other words, the mapping platform 108 may comprise one or more physical packages (such as chips) that include materials, components, and/or wires on a structural assembly (such as a baseboard).

In some example embodiments, the mapping platform 108 may include the processing server 116 for carrying out the processing functions associated with the mapping platform 108 and the map database 114 for storing map data. In an embodiment, the processing server 116 may include one or more processors configured to process requests received from the apparatus 102. The one or more processors may fetch sensor data and/or map data from the map database 114 and transmit the same to the apparatus 102 in a format suitable for use by the apparatus 102.

Continuing further, the map database 114 may comprise suitable logic, circuitry, and interfaces that may be configured to store the sensor data and map data, which may be collected from the at least one image capture sensor and/or the vehicle. In an embodiment, the vehicle may be traveling on a first lane segment of the road segment, or in a region close to the first lane segment. In accordance with an embodiment, such sensor data may be updated in real-time or near real-time such as within a few seconds, a few minutes, or on an hourly basis, to provide accurate and up-to-date sensor data. The sensor data may be collected from any sensor that may inform the mapping platform 108 or the map database 114 of features within the geographic area that are appropriate for traffic-related services. In accordance with an embodiment, the sensor data may be collected from any sensor that may inform the mapping platform 108 or the map database 114 of features within the geographic area that are appropriate for mapping. For example, motion sensors, inertia sensors, image capture sensors, proximity sensors, LiDAR sensors, and ultrasonic sensors may be used to collect the sensor data. The gathering of massive quantities of crowd-sourced data may facilitate the accurate modeling and mapping of an environment, whether it is a road link or a link within a structure, such as in an interior of a multi-level parking structure.

The map database 114 may further be configured to store the traffic-related data and road topology and geometry-related data for a road network as map data. The map data may also include cartographic data, routing data, and maneuvering data. The map data may also include, but is not limited to, locations of intersections, diversions to be caused due to accidents, congestions or constructions, suggested roads, or links to avoid, and an estimated time of arrival (ETA) depending on different links. In accordance with an embodiment, the map database 114 may be configured to receive the map data including the road topology and geometry-related attributes related to the road network from external systems, such as one or more of background batch data services, streaming data services, and third-party service providers, via the communication network 104.

In accordance with an embodiment, the map data stored in the map database 114 may further include data about changes in traffic situations registered by GPS provider(s), such as, but not limited to, incidents, road repairs, heavy rains, snow, fog, time of day, day of a week, holiday or other events which may influence the traffic condition of a link segment.

In some embodiments, the map database 114 may further store historical probe data for events (such as, but not limited to, traffic incidents, construction activities, scheduled events, and unscheduled events) associated with Point of Interest (POI) data records or other records of the map database 114.

For example, the data stored in the map database 114 may be compiled (such as into a platform specification format (PSF)) to organize and/or processed for generating navigation-related functions and/or services, such as route calculation, route guidance, map display, speed calculation, distance and travel time functions, navigation instruction generation, and other functions, by a navigation device, such as a user equipment. The navigation-related functions may correspond to vehicle navigation, pedestrian navigation, navigation to a favored parking spot, or other types of navigation. While example embodiments described herein generally relate to vehicular travel, example embodiments may be implemented for bicycle travel along bike paths, boat travel along maritime navigational routes, etc. The compilation to produce the end-user databases may be performed by a party or entity separate from the map developer. For example, a customer of the map developer, such as a navigation device developer or other end user device developer, may perform compilation on the received map database 114 in a delivery format to produce one or more compiled navigation databases.

In some embodiments, the map database 114 may be a master geographic database configured on the side of the apparatus 102. In accordance with an embodiment, the map database 114 may represent a compiled navigation database that may be used in or with end-user devices to provide navigation instructions based on the traffic data, the traffic conditions, speed adjustment, ETAs, and/or map-related functions to navigate through the intersection connected links on the route.

In some embodiments, the map data may be collected by end-user vehicles (such as the vehicle) which use vehicles on-board one or more sensors to detect data about various entities such as road objects, lane markings, links, and the like. These vehicles are also referred to as probe vehicles and form an alternate form of data source for map data collection, along with ground-truth data. Additionally, data collection mechanisms like remote sensing, such as aerial or satellite photography may be used to collect the map data for the map database 114.

In some embodiments, the map database 114 may include lane and intersection data records or other data that may represent links in the route, pedestrian lane, or areas in addition to or instead of the vehicle lanes. The lanes and intersections may be associated with attributes, such as geographic coordinates, street names, lane identifiers, lane segment identifiers, lane traffic direction, address ranges, speed limits, turn restrictions at intersections, and other navigation-related attributes, as well as POIs, such as fueling stations or EVCPs. The map database 114 may additionally include data about places, such as cities, towns, or other communities, and other geographic features such as, but not limited to, bodies of water, and mountain ranges.

In some embodiments, images received from the image source, for example, the at least one image capture sensor may be stored within the map database 114 of the mapping platform 108. In certain cases, the mapping platform 108, using the processing server 116, may suitably process the received images. For example, such processing may include, suitably labeling the images based on corresponding associated lane and/or link, point of interest within the link and/or lane, and other information relating to the respective link and/or lane. Such labeled images may then be stored within the map database 114 as map data.

Many modifications and other embodiments of the present disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one non-transitory memory including computer program code instructions, the computer program code instructions configured to, when executed, cause the apparatus to:
receive electric vehicle charging point (EVCP) data associated with a plurality of EVCPs;
determine one or more clustering features for each of the plurality of EVCPs based on the EVCP data, wherein the one or more clustering features comprises a duration parameter, a predefined charging status parameter, a charging gap parameter, or a combination thereof;
generate, using a first model, one or more clusters based on the one or more clustering features, wherein each of the one or more clusters comprises at least one of the plurality of EVCPs; and
train a second model to predict availability data associated with each EVCP within each of the one or more clusters based on a data point associated with one or more EVCPs within said cluster.

2. The apparatus of claim 1, wherein the computer program code instructions are configured to, when executed, cause the apparatus to:
receive ground-truth availability data associated with each of the plurality of EVCPs;
determine a confidence score of the second model based on the availability data and the ground-truth availability data; and
update, using the first model, the one or more clusters based on the confidence score.

3. The apparatus of claim 2, wherein, to update the one or more clusters, the computer program code instructions are configured to, when executed, cause the apparatus to:
compare the confidence score with a confidence threshold; and
responsive to the confidence score failing to satisfy the confidence threshold, generate, using the first model, a plurality of updated clusters by increasing a number of the one or more clusters.

4. The apparatus of claim 3, wherein the computer program code instructions are configured to, when executed, cause the apparatus to:
re-train the second model to predict the availability data associated with each EVCP within each of the plurality of updated clusters based on a data point associated with one or more EVCPs within said updated cluster.

5. The apparatus of claim 1, wherein the computer program code instructions are configured to, when executed, cause the apparatus to:
receive vehicle information of a vehicle associated with the geographic area, wherein the vehicle information comprises location data and battery charge data; and
identify one or more EVCPs from the one or more clusters for the vehicle based on the vehicle information and the availability data.

6. The apparatus of claim 5, wherein the computer program code instructions are configured to, when executed, cause the apparatus to:
generate navigation instructions for the vehicle from a starting location to one of the one or more EVCPs from the one or more clusters.

7. The apparatus of claim 1, wherein the computer program code instructions are configured to, when executed, cause the apparatus to:
generate, using the first model, the one or more clusters based on one or more additional clustering features, wherein the one or more additional clustering features comprise a record parameter, a utilization parameter, or a combination thereof.

8. The apparatus of claim 1, wherein the EVCP data comprises geographic area data, weather condition associated with a geographic area, and one or more events associated with the geographic area of each of the plurality of EVCPs.

9. The apparatus of claim 1, wherein the duration parameter is a ratio of a number of a number of first charging events among second charging events that occurred at each of the plurality of EVCPs and a number of the second charging events, wherein each of the first charging events is less than a predefined duration.

10. The apparatus of claim 1, wherein the predefined charging status parameter is a ratio of a number of one or more events that occurred at each of the plurality of EVCPs and a number of status change for each of the plurality of EVCPs, wherein each of the one or more events is defined as a status other than a charging status or an unavailable status.

11. The apparatus of claim 1, wherein the charging gap parameter is an average duration between two consecutive charging events that occurred at each of the plurality of EVCPs.

12. A method comprising:
receiving electric vehicle charging point (EVCP) data associated with a plurality of EVCPs;
determining one or more clustering features for each of the plurality of EVCPs based on the EVCP data, wherein the one or more clustering features comprises a duration parameter, a predefined charging status parameter, a charging gap parameter, or a combination thereof;
generating, using a first model, one or more clusters based on the one or more clustering features, wherein each of the one or more clusters comprises at least one of the plurality of EVCPs; and
training a second model to predict availability data associated with each EVCP within each of the one or more clusters based on a data point associated with one or more EVCPs within said cluster.

13. The method of claim 12, further comprising:
receiving ground-truth availability data associated with each of the plurality of EVCPs;
determining a confidence score of the second model based on the availability data and the ground-truth availability data; and
updating, using the first model, the one or more clusters based on the confidence score.

14. The method of claim 13, wherein, to update the one or more clusters, the method further comprises:
comparing the confidence score with a confidence threshold; and
responsive to the confidence score failing to satisfy the confidence threshold, generating, using the first model, a plurality of updated clusters by increasing a number of the one or more clusters.

15. The method of claim 14, further comprising:
re-training the second model to predict the availability data associated with each EVCP within each of the plurality of updated clusters based on a data point associated with one or more EVCPs within said updated cluster from the one or more updated clusters.

16. The method of claim 12, further comprising:
receiving vehicle information of a vehicle associated with the geographic area, wherein the vehicle information comprises location data and battery charge data; and
identifying one or more EVCPs from the one or more clusters for the vehicle based on the vehicle information and the availability data.

17. The method of claim 16, further comprising:
generating navigation instructions for the vehicle from a starting location to one of the one or more EVCPs from the one or more clusters.

18. The method of claim 12, further comprising:
generating, using the first model, the one or more clusters based on one or more additional clustering features, wherein the one or more additional clustering features comprise a record parameter, a utilization parameter, or a combination thereof.

19. A computer programmable product comprising a non-transitory computer readable medium having stored thereon computer executable instructions, which when executed by one or more processors, cause the one or more processors to carry out operations comprising:
receiving electric vehicle charging point (EVCP) data associated with a plurality of EVCPs;
determining one or more clustering features for each of the plurality of EVCPs based on the EVCP data, wherein the one or more clustering features comprises a duration parameter, a predefined charging status parameter, a charging gap parameter, or a combination thereof;
generating, using a first model, one or more clusters based on the one or more clustering features, wherein each of the one or more clusters comprises at least one of the plurality of EVCPs; and
training a second model to predict availability data associated with each EVCP within each of the one or more clusters based on a data point associated with one or more EVCPs within said cluster.

20. The computer programmable product of claim 19, wherein the operations further comprise:
receiving ground-truth availability data associated with each of the plurality of EVCPs;
determining a confidence score of the second model based on the availability data and the ground-truth availability data; and
updating, using the first model, the one or more clusters based on the confidence score.
